(19) United States
(12) Patent Application Publication
(10) Pub. No.: US 2025/0238390 A1
(43) Pub. Date: Jul. 24, 2025

(54) PROCESSING METHOD AND APPARATUS FOR BASEBOARD MANAGEMENT CONTROLLER, AND PROCESSING METHOD AND APPARATUS FOR BASIC INPUT/OUTPUT SYSTEM

(71) Applicant: SUZHOU METABRAIN INTELLIGENT TECHNOLOGY CO., LTD., Suzhou (CN)

(72) Inventors: Dianwei WANG, Suzhou (CN); Baoyang LIU, Suzhou (CN); Chaofan CHEN, Suzhou (CN)

(21) Appl. No.: 19/175,829

(22) Filed: Apr. 10, 2025

Related U.S. Application Data
(63) Continuation of application No. PCT/CN2024/115902, filed on Aug. 30, 2024.

(30) Foreign Application Priority Data
Sep. 25, 2023 (CN) 202311244088.7

(51) Int. Cl. G06F 13/42

(52) U.S. Cl. CPC G06F 13/4221; G06F 2213/0026

(57) ABSTRACT

A method and apparatus for processing a baseboard management controller and a method and apparatus for processing a basic input/output system are provided by the present application, wherein the server includes a baseboard management controller, a basic input/output system and a shared memory space; the basic input/output system is connected to the baseboard management controller via a PCIe path; the baseboard management controller stores a second character string that is preset; the second character string is modified by the baseboard management controller to obtain a third character string corresponding to a second setup option in response to the baseboard management controller transmitting the second setup option to the basic input/output system. In the present application, a setup option is transmitted via the PCIe path, without adding a hardware module, and the transmission speed of the setup option is also improved.

### CROSS-REFERENCE TO RELATED APPLICATION

This application claims the priority of the Chinese Patent application filed on Sep. 25, 2023 before the China National Intellectual Property Administration with the application number of 202311244088.7, and the title of “PROCESSING METHOD AND APPARATUS FOR BASEBOARD MANAGEMENT CONTROLLER, AND PROCESSING METHOD AND APPARATUS FOR BASIC INPUT/OUTPUT SYSTEM”, which is incorporated herein in its entirety by reference.

### FIELD

The present application relates to the technical field of servers and, more particularly, to a method and apparatus for processing a baseboard management controller, and a method and apparatus for processing a basic input/output system.

### BACKGROUND

A baseboard management controller (BMC) is a controller used for monitoring and managing a server, and a basic input/output system (BIOS) is used for providing the bottommost and most direct hardware setup and control for the server, and providing some system parameters for the baseboard management controller, the basic input/output system and a boot-loaded operating system in the basic input/output system, etc. The system parameters are stored in a Setup module of the basic input/output system, and a user may modify the system parameters according to actual needs.

A Redfish is generally used in the related art to connect a baseboard management controller to the basic input/output system via a universal serial bus (USB) network card to transmit a setup option, and the baseboard management controller adjusts the baseboard management controller using the setup option transmitted via the Redfish. The USB network card hardware module is needed for transmitting the setup option using the Redfish, and the transmission speed of the setup option is slow.

### SUMMARY

A method and apparatus for processing a baseboard management controller and a method and apparatus for processing a basic input/output system are provided by the embodiment of the present application, so as to solve the problem that when the baseboard management controller adjusts the baseboard management controller by using a setup option transmitted via a Redfish, the USB network card hardware module is needed for transmitting the setup option using the Redfish, and the transmission speed of the setup option is slow.

A method for processing a baseboard management controller is provided by the embodiment of the present application, which is applied to a server, wherein the server includes a baseboard management controller, a basic input/output system and a shared memory space between the baseboard management controller and the basic input/output system; the basic input/output system further provides a setup interface; the basic input/output system is connected to the baseboard management controller via a peripheral component interconnect express (PCIe) path, and a setup interface is used for displaying setup options; the method includes:
collecting, by the basic input/output system, a first setup option and storing the first setup option in the shared memory space in response to the basic input/output system transmitting the first setup option to the baseboard management controller, before the setup interface is displayed and/or after the setup option is modified via the setup interface;
transmitting the first setup option to the baseboard management controller via the PCIe path; and
adjusting the baseboard management controller based on the first setup option by the baseboard management controller.

In some embodiments of the present application, the shared memory space includes a first area; and the step of collecting the first setup option and storing the first setup option in the shared memory space further includes:
converting the collected first setup option into a first character string by the basic input/output system;
calculating, by the basic input/output system, a length of the first character string based on the first character string, and determining whether the length of the first character string exceeds a preset length range;
taking the first character string as a second character string by the basic input/output system in response to the length of the first character string not exceeding the preset length range; and
storing the second character string in the first area by the basic input/output system.

In some embodiments of the present application, the first area further stores a first data field corresponding to the first character string; and the method further includes:
calculating a first check value of the first character string based on the first character string by the basic input/output system; and
storing the length of the first character string and the first check value in the first data field by the basic input/output system.

In some embodiments of the present application, the method further includes:
compressing the first character string by the basic input/output system to obtain a compressed character string in response to the length of the first character string exceeding the preset length range;
storing information about whether the first character string is compressed in the first data field by the basic input/output system;
calculating, by the basic input/output system, a length of the compressed character string, and determining whether the length of the compressed character string exceeds the preset length range; and
taking the compressed character string as the second character string by the basic input/output system in response to the length of the compressed character string being within the preset length range.

In some embodiments of the present application, the first data field further includes a first owner field; the first owner field is used for indicating an owner of the first area; and the step of storing the second character string in the first area further includes:
reading the first owner field by the basic input/output system to obtain the owner of the first area; and
modifying the first owner field to indicate that the owner of the first area is the basic input/output system and storing the second character string in the first area by the basic input/output system in response to the owner of the first area being the basic input/output system or the first area being not used.

In some embodiments of the present application, the method further includes:
pausing storing the second character string in the first area by the basic input/output system in response to the owner of the first area being the baseboard management controller; and
reading the first owner field again by the basic input/output system to obtain the owner of the first area.

In some embodiments of the present application, the first data field further includes a first validity field; the first validity field is used for indicating whether the second character string in the first area is valid; and after the step of storing the second character string in the first area, the method further includes:
indicating that the second character string of the first area is valid by modifying the first validity field by the basic input/output system.

In some embodiments of the present application, before the baseboard management controller adjusts the baseboard management controller based on the first setup option, the method further includes:
reading, by the baseboard management controller, the first validity field, and determining whether the second character string is valid;
reading the first owner field by the baseboard management controller to obtain the owner of the first area in response to the second character string being valid;
modifying the first owner field to indicate that the owner of the first area is the baseboard management controller and extracting the second character string by the baseboard management controller in response to the owner of the first area being the baseboard management controller or the first area being not used; and
parsing the second character string by the baseboard management controller to obtain the first setup option.

In some embodiments of the present application, the step of extracting the second character string further includes:
reading the first data field by the baseboard management controller to obtain the length of the first character string and information about whether the first character string is compressed;
determining whether the first character string exceeds the preset length range based on the length of the first character string by the baseboard management controller;
determining whether the first character string is compressed by the baseboard management controller based on the information about whether the first character string is compressed in response to the length of the first character string exceeding the preset length range;
ignoring the second character string by the baseboard management controller in response to the first character string being not compressed; and
extracting the second character string by the baseboard management controller in response to the first character string being compressed.

In some embodiments of the present application, the step of parsing the second character string to obtain the first setup option further includes:
reading the first data field by the baseboard management controller to obtain the first check value of the first character string;
calculating a second check value of the first character string by the baseboard management controller based on the first character string;
comparing, by the baseboard management controller, the first check value and the second check value, and determining whether the first check value and the second check value are the same;
ignoring the second character string by the baseboard management controller in response to the first check value and the second check value being not the same; and
parsing the second character string by the baseboard management controller to obtain the first setup option in response to the first check value and the second check value being the same.

In some embodiments of the present application, the method further includes:
pausing extracting the second character string by the baseboard management controller in response to the owner of the first area being the basic input/output system; and
reading the first owner field again by the baseboard management controller to obtain the owner of the first area.

A method for processing a basic input/output system is further provided by the embodiments of the present application, which is applied to a server, wherein the server includes a baseboard management controller, the basic input/output system and a shared memory space between the baseboard management controller and the basic input/output system; the basic input/output system is connected to the baseboard management controller via a peripheral component interconnect express (PCIe) path; the baseboard management controller stores a second character string that is preset; and the method includes:
modifying the second character string to obtain a third character string corresponding to a second setup option by the baseboard management controller in response to the baseboard management controller transmitting the second setup option to the basic input/output system;
storing the third character string in the shared memory space by the baseboard management controller;
transmitting the third character string to the basic input/output system via the PCIe path;
parsing the third character string by the basic input/output system to obtain the second setup option; and
adjusting the basic input/output system by the basic input/output system based on the second setup option.

In some embodiments of the present application, the shared memory area further includes a second area, the second area is used for storing the third character string; a second data field corresponding to the third character string is further stored in the second area; the second data field includes a second owner field and a second validity field; the second owner field is used for indicating an owner of the second area, and the second validity field is used for indicating whether the third character string in the second area is valid; and the step of storing the third character string in the shared memory space further includes:
reading the second owner field by the baseboard management controller to obtain the owner of the second area;
modifying the second owner field to indicate that the owner of the second area is the baseboard management controller and storing the third character string in the second area by the baseboard management controller in response to the owner of the second area being the baseboard management controller or the second area being not used; and
indicating that the third character string is valid by modifying the second validity field by the baseboard management controller.

In some embodiments of the present application, before the step of parsing the third character string to obtain the second setup option, the method further includes:
reading, by the basic input/output system, the second validity field and determining whether the third character string is valid; and
extracting the third character string by the basic input/output system in response to the third character string being valid;
parsing the third character string by the basic input/output system to obtain the second setup option.

In some embodiments of the present application, the shared memory area further includes a third area; and the step of adjusting the basic input/output system based on the second setup option further includes:
determining whether the second setup option satisfies a preset format requirement by the basic input/output system;
adjusting the basic input/output system based on the second setup option by the basic input/output system in response to the second setup option satisfies the preset format requirement; and
converting, by the basic input/output system, the second setup option into a fourth character string, and storing the fourth character string in the third area in response to the second setup option not satisfying the preset format requirement; wherein the fourth character string is used for determining whether the second setup option satisfying the preset format requirement.

In some embodiments of the present application, the method further includes:
restarting the server, such that the server is adapted to the second setup option, in response to the second setup option satisfying the preset format requirement.

Another method for processing the baseboard management controller is further provided by the embodiments of the present application, which is applied to a server, wherein the server includes the baseboard management controller, a basic input/output system and a shared memory space between the baseboard management controller and the basic input/output system; the basic input/output system is connected to the baseboard management controller via a peripheral component interconnect express (PCIe) path; the shared memory space stores a fourth character string that is preset; and the method includes:
transmitting the fourth character string to the baseboard management controller via the PCIe path in response to the basic input/output system transmitting the fourth character string to the baseboard management controller; and
extracting, by the baseboard management controller, the fourth character string, and determining whether a second setup option corresponding to the fourth character string satisfies a preset format requirement based on the fourth character string.

An apparatus for processing a baseboard management controller is further provided by the embodiments of the present application, which is disposed in a server, wherein the server includes the baseboard management controller, a basic input/output system and a shared memory space between the baseboard management controller and the basic input/output system; the basic input/output system further provides a setup interface; the basic input/output system is connected to the baseboard management controller via a peripheral component interconnect express (PCIe) path, and the setup interface is used for displaying setup options; the basic input/output system includes an acquisition module; the PCIe path includes a first transmission module; the baseboard management controller includes a first adjustment module; and the apparatus includes:
the acquisition module configured to collect, by the basic input/output system, a first setup option and store the first setup option in the shared memory space in response to the basic input/output system transmitting the first setup option to the baseboard management controller, before the setup interface is displayed and/or after the setup option is modified via the setup interface;
the first transmission module configured to transmit the first setup option to the baseboard management controller via the PCIe path; and
the first adjustment module configured to adjust the baseboard management controller based on the first setup option by the baseboard management controller.

In some embodiments of the present application, the shared memory space includes a first area; and the acquisition module further includes:
a first conversion module configured to convert the collected first setup option into a first character string by the basic input/output system;
a first calculation module configured to calculate, by the basic input/output system, a length of the first character string based on the first character string, and determine whether the length of the first character string exceeds a preset length range;
a first action module configured to take the first character string as a second character string by the basic input/output system in response to the length of the first character string not exceeding the preset length range; and
a first storage module configured to store the second character string in the first area by the basic input/output system.

In some embodiments of the present application, the first area further stores a first data field corresponding to the first character string; the basic input/output system includes a second calculation module and a second storage module, and the apparatus further includes:
a second calculation module configured to calculate a first check value of the first character string based on the first character string by the basic input/output system; and
a second storage module configured to store the length of the first character string and the first check value in the first data field by the basic input/output system.

In some embodiments of the present application, the basic input/output system includes a compression module, a third storage module, a third calculation module and a second action module, and the apparatus further includes:
a compression module configured to compress the first character string by the basic input/output system to obtain a compressed character string in response to the length of the first character string exceeding the preset length range;
a third storage module configured to store information about whether the first character string is compressed in the first data field by the basic input/output system;
a third calculation module configured to calculate, by the basic input/output system, the length of the compressed character string, and determine whether the length of the compressed character string exceeds the preset length range; and
a second action module configured to take the compressed character string as the second character string by the basic input/output system in response to the length of the compressed character string being within the preset length range.

In some embodiments of the present application, the first data field further includes a first owner field; the first owner field is used for indicating the owner of the first area; the first storage module further includes:
a first read module configured to read the first owner field by the basic input/output system to obtain the owner of the first area; and
a fourth storage module configured to store the second character string in the first area by the basic input/output system in response to the owner of the first area being the basic input/output system.

In some embodiments of the present application, the basic input/output system includes a first pause module and a second read module, and the apparatus further includes:
a first pause module configured to pause storing the second character string in the first area by the basic input/output system in response to the owner of the first area being the baseboard management controller; and
a second read module configured to read the first owner field again by the basic input/output system to obtain the owner of the first area.

In some embodiments of the present application, the first data field further includes a first validity field; the first validity field is used for indicating whether the second character string in the first area is valid; the basic input/output system includes a first modification module, and the apparatus further includes:
a first modification module configured to indicate that the second character string of the first area is valid by modifying the first validity field by the basic input/output system.

In some embodiments of the present application, the baseboard management controller further includes a third read module, a fourth read module, a first extraction module and a first parsing module, and the apparatus further includes:
a third read module configured to read, by the baseboard management controller, the first validity field, and determine whether the second character string is valid;
a fourth read module configured to read the first owner field to obtain the owner of the first area by the baseboard management controller in response to the second character string being valid;
a first extraction module configured to extract the second character string by the baseboard management controller in response to the owner of the first area being the baseboard management controller; and
a first parsing module configured to parse the second character string by the baseboard management controller to obtain the first setup option.

In some embodiments of the present application, the first extraction module further includes:
a fifth read module configured to read the first data field by the baseboard management controller to obtain the length of the first character string and the information about whether the first character string is compressed;
a first determining module configured to determine whether the first character string exceeds the preset length range based on the length of the first character string by the baseboard management controller;
a second determining module configured to determine whether the first character string is compressed by the baseboard management controller based on the information about whether the first character string is compressed in response to the length of the first character string exceeding the preset length range;
a second ignoring module configured to ignore the second character string by the baseboard management controller in response to the first character string being not compressed; and
a second extraction module configured to extract the second character string by the baseboard management controller in response to the first character string being compressed.

In some embodiments of the present application, the first parsing module further includes:
a fifth read module configured to read the first data field by the baseboard management controller to obtain the first check value of the first character string;
a fourth calculation module configured to calculate a second check value of the first character string by the baseboard management controller based on the first character string;
a third determining module configured to compare, by the baseboard management controller, the first check value and the second check value, and determine whether the first check value and the second check value are the same;
a second ignoring module configured to ignore the second character string by the baseboard management controller in response to the first check value and the second check value being not the same; and
a second parsing module configured to parse the second character string by the baseboard management controller to obtain the first setup option in response to the first check value and the second check value being the same.

In some embodiments of the present application, the baseboard management controller further includes a second pause module and a sixth read module, and the apparatus further includes:
a second pause module configured to pause extracting the second character string by the baseboard management controller in response to the owner of the first area being the basic input/output system; and
a sixth read module configured to read the first owner field again by the baseboard management controller to obtain the owner of the first area.

An apparatus for processing a basic input/output system is further provided by the embodiments of the present application, which is applied to a server, wherein the server includes a baseboard management controller, the basic input/output system and a shared memory space between the baseboard management controller and the basic input/output system; the basic input/output system is connected to the baseboard management controller via a peripheral component interconnect express (PCIe) path; the baseboard management controller stores a second character string that is preset; the basic input/output system includes a third parsing module and a second adjustment module, the PCIe path includes a second transmission module, and the baseboard management controller includes a second modification module and a fifth storage module; and the apparatus includes:
the second modification module configured to modify the second character string to obtain a third character string corresponding to a second setup option by the baseboard management controller in response to the baseboard management controller transmitting the second setup option to the basic input/output system;
the fifth storage module configured to store the third character string in the shared memory space by the baseboard management controller;
the second transmission module configured to transmit the third character string to the basic input/output system via the PCIe path;
the third parsing module configured to parse the third character string by the basic input/output system to obtain the second setup option; and
the second adjustment module configured to adjust the basic input/output system by the basic input/output system based on the second setup option.

In some embodiments of the present application, the shared memory area further includes a second area used for storing the third character string; a second data field corresponding to the third character string is further stored in the second area; the second data field includes a second owner field and a second validity field; the second owner field is used for indicating an owner of the second area, and the second validity field is used for indicating whether the third character string in the second area is valid; the fifth storage module further includes:
a seventh read module configured to read the second owner field by the baseboard management controller to obtain the owner of the second area;
a sixth storage module configured to store the third character string in the second area by the baseboard management controller in response to the owner of the second area being the baseboard management controller; and
a third modification module configured to indicate that the third character string is valid by modifying the second validity field by the baseboard management controller.

In some embodiments of the present application, the basic input/output system further includes an eighth read module, a third extraction module and a fourth parsing module, and the apparatus further includes:
an eighth read module configured to read, by the basic input/output system, the second validity field and determine whether the third character string is valid; and
a third extraction module configured to extract the third character string by the basic input/output system in response to the third character string being valid.

In some embodiments of the present application, the shared memory area further includes a third area; and the second adjustment module further includes:
a fourth determining module configured to determine whether a second setup option satisfies a preset format requirement by the basic input/output system;
a third adjustment module configured to adjust the basic input/output system based on the second setup option by the basic input/output system in response to the second setup option satisfying the preset format requirement; and
a second conversion module configured to convert, by the basic input/output system, the second setup option into a fourth character string, and store the fourth character string in the third area in response to the second setup option not satisfying the preset format requirement; wherein the fourth character string is used for determining whether the second setup option satisfies the preset format requirement.

In some embodiments of the present application, the apparatus further includes:
a restart module configured to restart the server, such that the server is adapted to the second setup option, in response to the second setup option satisfying the preset format requirement.

An apparatus for processing a baseboard management controller is further provided by the embodiments of the present application, which is applied to a server, wherein the server includes the baseboard management controller, a basic input/output system and a shared memory space between the baseboard management controller and the basic input/output system; the basic input/output system is connected to the baseboard management controller via a peripheral component interconnect express (PCIe) path; the shared memory space stores a fourth character string that is preset; the PCIe path includes a third transmission module, and the baseboard management controller includes a fourth extraction module; and the apparatus includes:
the third transmission module configured to transmit the fourth character string to the baseboard management controller via the PCIe path in response to the basic input/output system transmitting the fourth character string to the baseboard management controller; and
the fourth extraction module configured to extract, by the baseboard management controller, the fourth character string, and determine whether a second setup option corresponding to the fourth character string satisfies a preset format requirement based on the fourth character string.

An electronic device is further provided by the embodiments of the present application, which includes a processor, a communication interface, a memory, and a communication bus, wherein the processor, the communication interface and the memory communicate with each other via the communication bus;
the memory is configured to store a server program; and
the processor, in response to executing the program stored on the memory, implements the method according to the embodiments of the present application.

A non-transitory readable storage medium is further provided by the embodiments of the present application, having stored thereon instructions which, in response to being executed by one or more processors, cause the one or more processors to perform the method according to the embodiments of the present application.

The embodiments of the present application include the following advantages:

A method and apparatus for processing a baseboard management controller and a method and apparatus for processing a basic input/output system are provided by the present application, which are applied to a server, wherein the server includes a baseboard management controller, a basic input/output system and a shared memory space between the baseboard management controller and the basic input/output system; the basic input/output system further provides a setup interface; the basic input/output system is connected to the baseboard management controller via a PCIe path, and the setup interface is used for displaying setup options; the basic input/output system collects a first setup option and stores the first setup option in the shared memory space in response to the basic input/output system transmitting a setup option to the baseboard management controller, before the setup interface is displayed and/or after the setup option is modified via the setup interface; the PCIe path transmits the first setup option to the baseboard management controller; the baseboard management controller adjusts the baseboard management controller based on the first setup option. In the present application, the setup options are transmitted via the PCIe path, without adding a hardware module, a transmission speed of the setup option is also improved, and the process of transmitting the setup options is safer and more reliable.

### BRIEF DESCRIPTION OF THE DRAWINGS

FIG. 1 is a flow chart of steps of a method for processing a baseboard management controller according to an embodiment of the present application;

FIG. 2 is a flow chart of steps of a method for processing a basic input/output system according to an embodiment of the present application;

FIG. 3 is a flow chart of steps of another method for processing a baseboard management controller according to an embodiment of the present application;

FIG. 4 is a structural block diagram of an apparatus for processing a baseboard management controller according to an embodiment of the present application;

FIG. 5 is a structural block diagram of an apparatus for processing a basic input/output system according to an embodiment of the present application;

FIG. 6 is a structural block diagram of another apparatus for processing baseboard management controller according to an embodiment of the present application;

FIG. 7 is a schematic diagram of a setup interface according to an embodiment of the present application;

FIG. 8 is a schematic diagram of a first data field according to an embodiment of the present application;

FIG. 9 is a schematic format diagram of a format of a second character string according to an embodiment of the present application;

FIG. 10 is a schematic format diagram of a fourth character string according to an embodiment of the present application;

FIG. 11 is a schematic flow diagram showing a basic input/output system transmitting a first setup option to a baseboard management controller according to an embodiment of the present application;

FIG. 12 is a schematic flow diagram showing a baseboard management controller receiving a first setup option transmitted by a basic input/output system according to an embodiment of the present application;

FIG. 13 is a schematic flow diagram showing a baseboard management controller transmitting a second setup option to a basic input/output system according to an embodiment of the present application;

FIG. 14 is a schematic flow diagram showing a basic input/output system processing a second setup option according to an embodiment of the present application;

FIG. 15 is a block diagram of an electronic device according to an embodiment of the present application;

FIG. 16 is a schematic diagram showing a non-transitory readable storage medium according to an embodiment of the present application;

FIG. 17 is a schematic structural diagram of a server according to an embodiment of the present application;

FIG. 18 is a schematic structural diagram of a server according to an embodiment of the present application; and

FIG. 19 is a schematic structural diagram of a data structure according to an embodiment of the present application.

### DETAILED DESCRIPTION

In order to make the above-mentioned objectives, features, and advantages of the present application more clearly understandable, the following provides a further detailed description of the present application in conjunction with the accompanying drawings and embodiments.

In order to facilitate the understanding of the technical solutions and technical effects of the embodiments of the present application, a brief description of the related art related to the present application will be provided below.

A baseboard management controller is a controller used for monitoring and managing a server, and a basic input/output system is used for providing the bottommost and most direct hardware setup and control for the server, and providing some system parameters for the baseboard management controller, the basic input/output system and a boot-loaded operating system in the basic input/output system, etc. The system parameters are stored in a setup module of the basic input/output system, and a user may modify the system parameters according to actual needs. In the related art, a Redfish is generally used to connect the baseboard management controller to the basic input/output system via a USB network card so as to transmit a setup option, and the amount of data of the setup option is relatively large, which is more than 100 Kilobyte (KB) bytes. Redfish is a management standard based on Hypertext Transfer Protocol safe (HTTP) service. The USB network card hardware module is needed for transmitting the setup option using the Redfish, and a transmission speed of the setup option is slow.

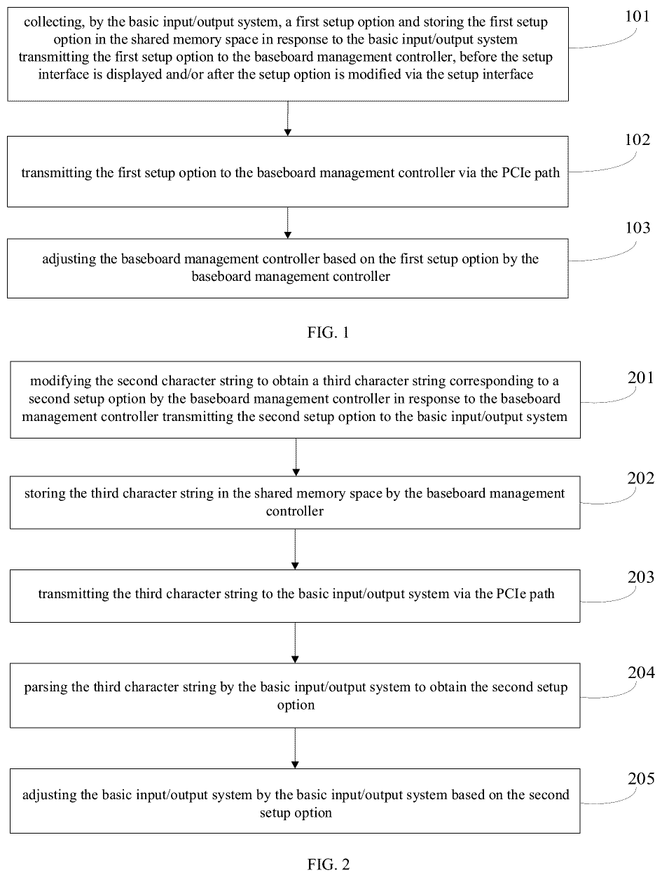

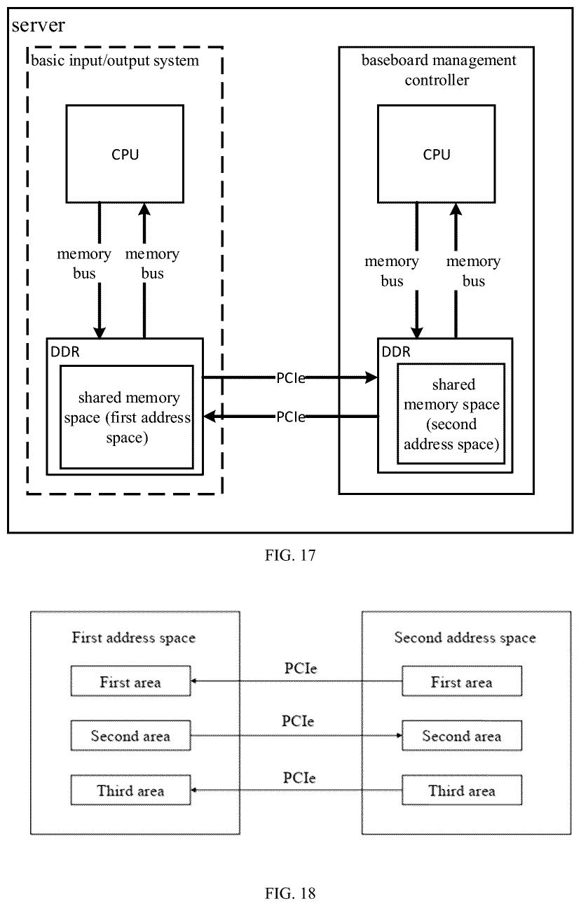

Referring to FIG. 1 and FIG. 17, FIG. 1 is a flow chart of steps of a method for processing a baseboard management controller according to an embodiment of the present application. FIG. 17 is a schematic structural diagram of a server according to an embodiment of the present application. The method is applied to a server, wherein the server includes the baseboard management controller, a basic input/output system and a shared memory space between the baseboard management controller and the basic input/output system; the basic input/output system further provides a setup interface; the basic input/output system is connected to the baseboard management controller via a PCIe path, and the setup interface is used for displaying setup options; the method may include the following steps:

Step 101, collecting, by the basic input/output system, a first setup option and storing the first setup option in the shared memory space in response to the basic input/output system transmitting the first setup option to the baseboard management controller, before the setup interface is displayed and/or after the setup option is modified via the setup interface.

In the embodiment of the present application, referring to FIG. 1 and FIG. 17, the server includes the baseboard management controller, the basic input/output system and the shared memory space. The basic input/output system further provides a setup interface that displays the setup options. The user observes the setup options through the setup interface, and modifies the setup options according to needs so as to modify the system parameters corresponding to the setup options. The setup options include names of the setup options and values to which the setup options correspond. Different setup options have different format requirements, such as the names of the setup options and yes/no, the names of the setup options and any number from 1 to 10, etc.

Referring to FIG. 17, the baseboard management controller and the basic input/output system are connected via the PCIe path, wherein the basic input/output system runs in a server host, and the baseboard management controller is one terminal device of the PCIe path and runs independently of the server host. The PCIe is a high-speed serial computer expansion bus standard. The baseboard management controller transmits an instruction for applying for an address space to a basic input/output system; the basic input/output system applies for a segment of a first address space to the server host through a base address register in the PCIe configuration space in the basic input/output system; the baseboard management controller also has a second address space corresponding to the first address space; and the first address space and the second address space together constitute a shared memory space between the baseboard management controller and the basic input/output system.

The setup module of the basic input/output system stores a large number of system parameters of the baseboard management controller, and a user may modify the setup options according to needs so as to modify the system parameters. When the basic input/output system needs to transmit the setup option to the baseboard management controller, after the basic input/output system enters the setup interface and/or a user modifies the setup option according to actual needs so as to modify the system parameter, the basic input/output system collects all the setup options as a first setup option, and stores the first setup option in the shared memory space.

Step 102, transmitting the first setup option to the baseboard management controller via the PCIe path.

In the embodiment of the present application, referring to FIG. 1, FIG. 17 and FIG. 18, the PCIe bus hardware transmits the first setup option stored in the shared memory space to the baseboard management controller.

Step 103, adjusting the baseboard management controller based on the first setup option by the baseboard management controller.

After receiving the first setup option, the baseboard management controller may analyze the first setup option, find the first setup option related to the baseboard management controller, and adjust the baseboard management controller according to the system parameters corresponding to the first setup option related to the baseboard management controller. The baseboard management controller may also save the received first setup option in a file, and names the file as current_setting.json.

In the embodiment of the present application, referring to FIG. 1 and FIG. 17, the server includes a baseboard management controller, a basic input/output system and a shared memory space between the baseboard management controller and the basic input/output system; the basic input/output system is connected to the baseboard management controller via the PCIe path; the basic input/output system further provides a setup interface, and the setup interface is used for displaying setup options; the basic input/output system collects a first setup option and stores the first setup option in the shared memory space in response to the basic input/output system transmitting the first setup option to the baseboard management controller, before the server displays the setup interface and/or after the setup option is modified via the setup interface; the PCIe path transmits the first setup option to the baseboard management controller; and the baseboard management controller adjusts the baseboard management controller based on the first setup option. In the present application, the setup options are transmitted via the PCIe path, without adding a hardware module, a transmission speed of the setup option is also improved, and the process of transmitting the setup options is safer and more reliable.

Further, in some embodiments of the present application described above, referring to FIG. 17 and FIG. 18, the shared memory space includes a first area; step 101 further includes:
sub-step S21, converting the collected first setup option into a first character string by the basic input/output system;
sub-step S22, calculating, by the basic input/output system, a length of the first character string based on the first character string, and determining whether the length of the first character string exceeds a preset length range;
sub-step S23, taking the first character string as a second character string by the basic input/output system in response to the length of the first character string not exceeding the preset length range; and
sub-step S24, storing the second character string in the first area by the basic input/output system.

In the embodiment of the present application, the shared memory area includes a first area, also referred to as a current setup area, for storing the setup options transmitted by the basic input/output system to the baseboard management controller.

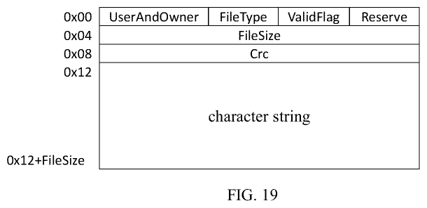

Referring to FIG. 19, FIG. 19 is a schematic structural diagram of a data structure according to an embodiment of the present application. In the present application, the data structure of the first area, the data structure of the second area and the data structure of the third area are the same. In FIG. 19, UserAndOwner refers to an owner of the corresponding area (for example, the owner of the first area), FileType refers to a type of a file and represents whether the character string is compressed, ValidFlag refers to whether the data is valid, FileSize refers to a size of a file, and Crc refers to a check value of the character string.

Referring to FIG. 19, the basic input/output system converts the collected first setup option into the first character string in a Json format, and calculates the length of the first character string. The basic input/output system determines whether the first character string exceeds a preset length range based on the length of the first character string, i.e., a length range of the first area in the shared memory space. The basic input/output system takes the first character string as the second character string in response to the first character string being within a preset length range. The basic input/output system stores the second character string in the first area. According to the embodiment of the present application, a first character string within the preset length range is stored in the first area, ensuring that the first character string may be successfully stored in the first area, and is successfully transmitted to the baseboard management controller.

Further, in some embodiments of the above-mentioned present application, referring to FIG. 19, the first area further stores a first data field corresponding to the first character string; the method further includes:
calculating a first check value of the first character string based on the first character string by the basic input/output system; and
storing the length of the first character string and the first check value in the first data field by the basic input/output system.

In the embodiment of the present application, referring to FIG. 19, the first area further stores a first data field corresponding to the first character string, i.e., a data header of the first area. The basic input/output system converts the collected first setup option into a first character string in a Json format, and calculates the first check value of the first character string. The basic input/output system further stores the length of the first character string and the first check value in the first data field, such that when receiving the first setup option, the baseboard management controller determines whether the first character string corresponding to the first setup option is correct.

Further, in some embodiments of the present application described above, the method further includes:
compressing the first character string by the basic input/output system to obtain a compressed character string in response to the length of the first character string exceeding the preset length range;
storing information about whether the first character string is compressed in the first data field by the basic input/output system;
calculating, by the basic input/output system, a length of the compressed character string, and determining whether the length of the compressed character string exceeds the preset length range; and
taking the compressed character string as the second character string by the basic input/output system in response to the length of the compressed character string being within the preset length range.

In the embodiment of the present application, the basic input/output system determines whether the first character string exceeds the preset length range based on the length of the first character string, i.e., a length range of the first area in the shared memory space. The first character string is compressed to obtain a compressed character string in response to the length of the first character string exceeding the preset length range. The basic input/output system again determines whether the length of the compressed character string exceeds the preset length range. The basic input/output system exits a flow of transmitting the first setup option to the baseboard management controller, and transmits error information to the basic input/output system in response to the length of the compressed character string still exceeding the preset length range. The basic input/output system takes the compressed character string as the second character string in response to the length of the compressed character string being within the preset length range. The basic input/output system stores the second character string in the first area. According to the embodiment of the present application, a compressed character string within the preset length range is stored in the first area, ensuring that the compressed character string may be successfully stored in the first area, and is successfully transmitted to the baseboard management controller.

Further, in some embodiments of the present application described above, the first data field further includes a first owner field; the first owner field is used for indicating an owner of the first area; and the step of storing the second character string in the first area further includes:
reading the first owner field by the basic input/output system to obtain the owner of the first area; and
modifying the first owner field to indicate that the owner of the first area is the basic input/output system and storing the second character string in the first area by the basic input/output system in response to the owner of the first area being the basic input/output system or the first area being not used.

In the embodiment of the present application, referring to FIG. 19, the first data field further includes a first owner field, and the first owner field indicates the owner of the first area. Before the basic input/output system stores the second character string in the first area, the basic input/output system reads the first owner field to obtain the owner of the first area. The basic input/output system stores the second character string in the first area in response to the owner of the first area being the basic input/output system or the first area being not used, ensuring a smooth progress of the storage process.

Further, in some embodiments of the present application described above, the method further includes:
pausing storing the second character string in the first area by the basic input/output system in response to the owner of the first area being the baseboard management controller; and
reading the first owner field again by the basic input/output system to obtain the owner of the first area.

In the embodiment of the present application, referring to FIG. 19, the first data field further includes a first owner field, and the first owner field indicates the owner of the first area. Before the basic input/output system stores the second character string in the first area, the basic input/output system reads the first owner field to obtain the owner of the first area. In response to the owner of the first area being the baseboard management controller, the basic input/output system pauses storing the second character string in the first area, sleeps for two seconds, reads the first owner field again, and determines the owner of the first area until the owner of the first area is the basic input/output system or the first area is not used, and the basic input/output system stores the second character string in the first area. The basic input/output system exits a flow of transmitting the first setup option to the baseboard management controller, and transmits error information to the basic input/output system in response to the owner of the first area being the baseboard management controller after retrying for 3 times.

Further, in some embodiments of the present application described above, referring to FIG. 19, the first data field further includes a first validity field; the first validity field is used for indicating whether the second character string in the first area is valid; after the storing the second character string in the first area, the method further includes:
indicating that the second character string of the first area is valid by modifying the first validity field by the basic input/output system.

In the embodiment of the present application, the first data field further includes a first validity field which may indicate whether the second character string is valid. After the basic input/output system stores the second character string in the first area, the basic input/output system modifies the first validity field to be 1, it is indicated that the second character string is valid, facilitating the baseboard management controller to determine whether the second character string corresponding to the first setup option is valid when receiving the first setup option.

The basic input/output system may also modify the first owner field to remove the basic input/output system from use.

Further, in some embodiments of the present application described above, before step 103, the method further includes:
reading, by the baseboard management controller, the first validity field, and determining whether the second character string is valid;
reading the first owner field by the baseboard management controller to obtain the owner of the first area in response to the second character string being valid;
modifying the first owner field to indicate that the owner of the first area is the baseboard management controller and extracting the second character string by the baseboard management controller in response to the owner of the first area being the baseboard management controller or the first area being not used; and
parsing the second character string by the baseboard management controller to obtain the first setup option.

In the embodiment of the present application, when the baseboard management controller receives the first setup option, the first validity field is firstly read, in response to the first validity field being 0, it is indicated that the second character string is invalid, then the baseboard management controller exits the flow of receiving the first setup option. The baseboard management controller reads the first owner field to obtain the owner of the first area in response to the first validity field being 1, it is indicated that the second character string is valid. The first owner field is modified to indicate that the owner of the first area is the baseboard management controller, and the second character string is extracted in response to the owner of the first area being the baseboard management controller or the first area being not used. After the baseboard management controller extracts the second character string, the first validity field is modified to 0, and the first owner field is modified to release the baseboard management controller from use. The baseboard management controller parses the second character string to obtain the first setup option corresponding to the second character string.

Further, in some embodiments of the present application described above, the step of extracting the second character string further includes:
reading the first data field by the baseboard management controller to obtain the length of the first character string and information about whether the first character string is compressed;
determining whether the first character string exceeds the preset length range based on the length of the first character string by the baseboard management controller;
determining whether the first character string is compressed by the baseboard management controller based on the information about whether the first character string is compressed in response to the length of the first character string exceeding the preset length range;
ignoring the second character string by the baseboard management controller in response to the first character string being not compressed; and
extracting the second character string by the baseboard management controller in response to the first character string being compressed.

In the embodiment of the present application, when the baseboard management controller receives the first setup option, the baseboard management controller reads the first data field to obtain the length of the first character string and information about whether the first character string is compressed. A problem occurs in the second character string, and the baseboard management controller does not extract the second character string in response to the length of the first character string exceeding the preset length range, and the first character string being not compressed. The baseboard management controller extracts the second character string and decompresses the second character string in response to the length of the first character string exceeding the preset length range, and the first character string being compressed. The second character string is directly extracted in response to the first character string not exceeding the preset length range, ensuring that the second character string extracted by the baseboard management controller is correct, and the baseboard management controller adjusts the baseboard management controller based on the first setup option smoothly.

Further, in some embodiments of the above-mentioned present application, the step of parsing the second character string to obtain the first setup option further includes:
reading the first data field by the baseboard management controller to obtain the first check value of the first character string;
calculating a second check value of the first character string by the baseboard management controller based on the first character string;
comparing, by the baseboard management controller, the first check value and the second check value, and determining whether the first check value and the second check value are the same;
ignoring the second character string by the baseboard management controller in response to the first check value and the second check value being not the same; and
parsing the second character string by the baseboard management controller to obtain the first setup option in response to the first check value and the second check value being the same.

In the embodiment of the present application, when the baseboard management controller receives the first setup option, the baseboard management controller reads the first data field to obtain the first check value of the first character string, and calculates the second check value of the first character string. The baseboard management controller determines whether the first check value and the second check value are the same; a problem occurs in the second character string, and the baseboard management controller ignores the second character string in response to the first check value and the second check value being not the same; the baseboard management controller parses the second character string to obtain the first setup option in response to the first check value and the second check value being the same. The baseboard management controller finds the first setup option related to the baseboard management controller, and calls a relevant functional module in the baseboard management controller to adjust the baseboard management controller according to a system parameter corresponding to the first setup option related to the baseboard management controller. The baseboard management controller may also save the second character string in current_setting.json.

Further, in some embodiments of the present application described above, the method further includes:
pausing extracting the second character string by the baseboard management controller in response to the owner of the first area being the basic input/output system; and
reading the first owner field again by the baseboard management controller to obtain the owner of the first area.

In the embodiment of the present application, in response to the owner of the first area being a basic input/output system, the baseboard management controller pauses extracting the second character string, sleeps for two seconds, reads the first owner field again, and determines the owner of the first area, until the owner of the first area is the baseboard management controller or the first area is not used, and the baseboard management controller extracts the second character string. The baseboard management controller exits the process of extracting the second character string in response to the owner of the first area being the basic input/output system after retrying three times.

Referring to FIG. 2, FIG. 17 and FIG. 18, FIG. 2 is a method for processing a basic input/output system provided in the embodiment of the present application, the method is applied to a server, wherein the server includes a baseboard management controller, the basic input/output system and a shared memory space between the baseboard management controller and the basic input/output system; the basic input/output system is connected to the baseboard management controller via a PCIe path; the baseboard management controller stores a second character string that is preset;
the method may include the following steps:

Step 201, modifying the second character string to obtain a third character string corresponding to a second setup option by the baseboard management controller in response to the baseboard management controller transmitting the second setup option to the basic input/output system.

In the embodiment of the present application, the server includes a baseboard management controller and a basic input/output system. The second character string corresponding to the first setup option transmitted by the basic input/output system is stored in a disk of the baseboard management controller, and the second character string is stored in the current_setting.json file. The baseboard management controller may modify the first setup option received from the basic input/output system, take the modified first setup option as the second setup option, and transmit the second setup option to the basic input/output system. When the baseboard management controller transmits the second setup option to the basic input/output system, the baseboard management controller modifies the content specified by the user in the current_setting.json file, i.e., the content modified by the user specified in the second character string, so as to obtain the future_setting.json file. The third character string corresponding to the second setup option is stored in the future_setting.json file.

Step 202, storing the third character string in the shared memory space by the baseboard management controller.

In the embodiment of the present application, the server further includes a shared memory space, and the baseboard management controller may store the third character string in the shared memory space.

Step 203, transmitting the third character string to the basic input/output system via the PCIe path.

In the embodiment of the present application, the PCIe bus hardware may transmit the third character string of characters stored in the shared memory space to the basic input/output system.

Step 204, parsing the third character string by the basic input/output system to obtain the second setup option.

In the embodiment of the present application, the basic input/output system may receive the third character string and parse the third character string to obtain a data linked list composed of a plurality of nodes, wherein each node is composed of a parameter name and a parameter value corresponding to a second setup option.

Step 205, adjusting the basic input/output system by the basic input/output system based on the second setup option.

The baseboard management controller may adjust the baseboard management controller based on the system parameter corresponding to the second setup option.

Further, in some embodiments of the present application described above, referring to FIG. 19, the shared memory area further includes a second area used for storing the third character string; a second data field corresponding to the third character string is further stored in the second area; the second data field includes a second owner field and a second validity field; the second owner field is used for indicating an owner of the second area, and the second validity field is used for indicating whether the third character string in the second area is valid; step 202 further includes:
sub-step S31, reading the second owner field by the baseboard management controller to obtain the owner of the second area;
sub-step S32, modifying the second owner field to indicate that the owner of the second area is the baseboard management controller and storing the third character string in the second area by the baseboard management controller in response to the owner of the second area being the baseboard management controller or the second area being not used; and
sub-step S33, indicating that the third character string is valid by modifying the second validity field by the baseboard management controller.

In the embodiment of the present application, the shared memory area includes a second area, also referred to as a modification setup area, for storing a setup option, i.e., a third character string, transmitted by the baseboard management controller to the basic input/output system. A second data field corresponding to the third character string is further stored in the second area; the second data field includes a second owner field and a second validity field; the second owner field is used for indicating an owner of the second area, and the second validity field is used to indicate whether the third character string is valid.

When the baseboard management controller transmits the third character string to the basic input/output system, the baseboard management controller third character string, and checks whether the third character string satisfies a preset format requirement, and the setup options include names of the setup options and values to which the setup options correspond. Different setup options have different format requirements, such as the names of the setup options and yes/no, the names of the setup options and any number from 1 to 10, etc.

The baseboard management controller also has a screen. Error information is displayed on the screen of the baseboard management controller, and the flow of transmitting the third character string to the basic input/output system is exited in response to the third character string not meeting the format requirements. The baseboard management controller calculates a length of the third character string and a third check value in response to the third character string not satisfying the format requirement.

When the baseboard management controller transmits the third character string to the basic input/output system, the baseboard management controller needs to store the third character string in the second area. Before the baseboard management controller stores the third character string in the second area, the baseboard management controller reads the second owner field to obtain the owner of the second area. The second owner field is modified to indicate that the owner of the second area is the baseboard management controller, and the third character string is stored in the second area in response to the owner of the second area being the baseboard management controller or the second area is not used. After the baseboard management controller stores the third character string in the second area, the second validity field is modified to 1, and the second owner field is modified to release the use of the baseboard management controller.

The basic input/output system pauses storing the third character string in the second area, sleeps for two seconds, reads the second owner field again, and determines the owner of the second area until the owner of the second area is the baseboard management controller or the second area is not used, and the baseboard management controller stores the third character string in the second area in response to the owner of the second area being the basic input/output system. The baseboard management controller exits the flow of transmitting the second setup option to the basic input/output system in response to the owner of the second area being the basic input/output system after retrying three times.

Further, in some embodiments of the present application described above, before step 204, the method further includes:
reading, by the basic input/output system, the second validity field and determining whether the third character string is valid; and
extracting the third character string by the basic input/output system in response to the third character string being valid.

In the embodiment of the present application, the basic input/output system circularly checks the second validity field in a modification setup area, i.e., a second area, and after the second validity field becomes 1, the basic input/output system reads the second owner field to obtain the owner of the second area. The second owner field is modified to indicate that the owner of the second area is the basic input/output system, and a third character string is extracted in response to the owner of the second area being the basic input/output system or the second area being not used. After the basic input/output system extracts the third character string, the second validity field is modified to 0, and the second owner field is modified to release the use of the basic input/output system. The basic input/output system parses the third character string to obtain a data linked list composed of a plurality of nodes, wherein each node is composed of a parameter name and a parameter value corresponding to a second setup option.

Further, in some embodiments of the present application described above, the shared memory area further includes a third area; step 205 further includes:
sub-step S31, determining whether the second setup option satisfies a preset format requirement by the basic input/output system;
sub-step S32, adjusting the basic input/output system based on the second setup option by the basic input/output system in response to the second setup option satisfying the preset format requirement; and
sub-step S33, converting, by the basic input/output system, the second setup option into a fourth character string, and storing the fourth character string in the third area in response to the second setup option not satisfying the preset format requirement; wherein the fourth character string is used for determining whether the second setup option satisfies the preset format requirement.

In the embodiment of the present application, the basic input/output system parses the third character string to obtain a data linked list composed of a plurality of nodes, wherein each node is composed of a parameter name and a parameter value corresponding to a second setup option. The basic input/output system checks the parameter name and parameter value of each node, in response to it meeting the format requirements of the setup options, it is placed in a designated location of a non-transitory storage medium. At the next start-up of the basic input/output system, the basic input/output system may read out the parameter name and the parameter value corresponding to the second setup option which meet the requirements from the non-transitory storage medium, so as to guide an operation of the basic input/output system. The parameter name and parameter value corresponding to the second setup option which does not meet the requirements and the cause of the non-compliance are converted into a fourth character string, and the fourth character string is put into an error list in response to the format requirements of the setup options being not met.

In the embodiment of the present application, the shared memory space further includes a third area. When the basic input/output system transmits the fourth character string to the baseboard management controller, the basic input/output system needs to store the fourth character string in the third area, i.e., a setup result area. Before the basic input/output system stores the fourth character string in the third area, the basic input/output system reads the owner field of the third area to obtain the owner of the third area. Modifying the owner field of the third area indicates that the owner of the third area is the basic input/output system, and the fourth character string is stored in the third area in response to the owner of the third area being the basic input/output system or the third area is not used. After the basic input/output system stores the fourth character string in the third area, the validity field of the third area is modified to 1, and the owner field of the third area is modified to release the use of the basic input/output system.

Further, in some embodiments of the present application described above, the method further includes:
restarting the server, such that the server is adapted to the second setup option, in response to the second setup option satisfying the format requirements of the setup option.

In the embodiment of the present application, in response to the second setup option complying with the format requirements of the setup option, since the system parameters corresponding to the second setup option may be different from the running system parameters, the server needs to be restarted to adapt the system parameters corresponding to the second setup option.

Referring to FIG. 3, FIG. 17 and FIG. 18, FIG. 3 is a method for processing a baseboard management controller provided by an embodiment of the present application. The method is applied to a server, wherein the server includes a baseboard management controller, a basic input/output system and a shared memory space between the baseboard management controller and the basic input/output system; the basic input/output system is connected to the baseboard management controller via a PCIe path; the shared memory space stores a fourth character string that is preset; and the steps are as follows:
step 301, transmitting the fourth character string to the baseboard management controller via the PCIe path in response to the basic input/output system transmitting the fourth character string to the baseboard management controller; and
step 302, extracting, by the baseboard management controller, the fourth character string, and determining whether a second setup option corresponding to the fourth character string satisfies a preset format requirement based on the fourth character string.

In the embodiment of the present application, the server includes the baseboard management controller, the basic input/output system and the shared memory space. The baseboard management controller and the basic input/output system are connected via a PCIe path; the shared memory space includes a third area; a fourth character string is further stored in the third area; and the PCIe path may transmit the fourth character string to the baseboard management controller. The baseboard management controller circularly checks a validity field in the third area, and after the validity field becomes 1, the baseboard management controller reads the owner field in the third area to obtain the owner of the third area. The owner field in the third area is modified to indicate that the owner of the third area is the baseboard management controller, and a fourth character string is extracted in response to the owner of the third area being the baseboard management controller or the third area is not used. After the baseboard management controller extracts the fourth character string, the validity field of the third area is modified to 0, and the owner field of the third area is modified to release the use of the baseboard management controller. The baseboard management controller parses the fourth character string, in response to the fourth character string indicating that there is a problem in the second setup option, a parameter name of a setup error and cause of the error are displayed to the user via a screen of the baseboard management controller. On the condition that there is no problem with the second setup option, the user is shown that the setup is successful and the fourth character string is saved as a file named setup_result.json.

It should be noted that for simplicity of explanation, method embodiments have been presented as a series of combinations of acts, but a person skilled in the art will recognize that the disclosed embodiments are not limited by the illustrated order of acts, as some acts may, according to the disclosed embodiments, occur in other orders or concurrently. Further, a person skilled in the art will also appreciate that the embodiments described in the specification are presently considered to be preferred embodiments, and that the acts involved are not necessarily required by the embodiments of the present application.

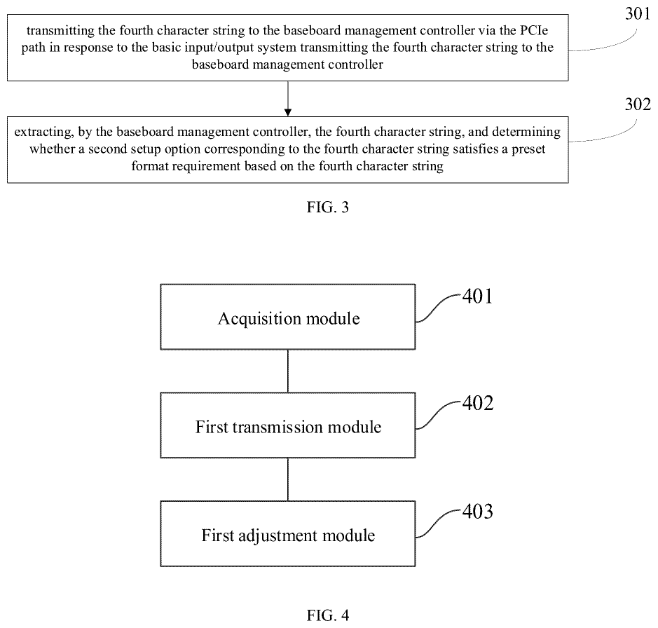

Referring to FIG. 4, FIG. 4 is a structural block diagram of an apparatus for processing a baseboard management controller according to an embodiment of the present application, and the following modules may be included:
an acquisition module 401 configured to collect, by the basic input/output system, a first setup option and store the first setup option in the shared memory space in response to the basic input/output system transmitting the first setup option to the baseboard management controller, before the setup interface is displayed and/or after the setup option is modified via the setup interface;
a first transmission module 402 configured to transmit the first setup option to the baseboard management controller via the PCIe path; and
a first adjustment module 403 configured to adjust the baseboard management controller based on the first setup option by the baseboard management controller.

In some embodiments of the present application, the shared memory space includes a first area; and the acquisition module further includes:
a first conversion module configured to convert the collected first setup option into a first character string by the basic input/output system;
a first calculation module configured to calculate, by the basic input/output system, a length of the first character string based on the first character string, and determine whether the length of the first character string exceeds a preset length range;
a first action module configured to take the first character string as a second character string by the basic input/output system in response to the length of the first character string not exceeding the preset length range; and
a first storage module configured to store the second character string in the first area by the basic input/output system.

In some embodiments of the present application, the first area further stores a first data field corresponding to the first character string; the basic input/output system includes a second calculation module and a second storage module, and the apparatus further includes:
a second calculation module configured to calculate a first check value of the first character string based on the first character string by the basic input/output system; and
a second storage module configured to store the length of the first character string and the first check value in the first data field by the basic input/output system.

In some embodiments of the present application, the basic input/output system includes a compression module, a third storage module, a third calculation module and a second action module, and the apparatus further includes:
a compression module configured to compress the first character string by the basic input/output system to obtain a compressed character string in response to the length of the first character string exceeding the preset length range;
a third storage module configured to store information about whether the first character string is compressed in the first data field by the basic input/output system;
a third calculation module configured to calculate, by the basic input/output system, the length of the compressed character string, and determine whether the length of the compressed character string exceeds the preset length range; and
a second action module configured to take the compressed character string as the second character string by the basic input/output system in response to the length of the compressed character string being within the preset length range.

In some embodiments of the present application, the first data field further includes a first owner field; the first owner field is used for indicating the owner of the first area; the first storage module further includes:
a first read module configured to read the first owner field by the basic input/output system to obtain the owner of the first area; and
a fourth storage module configured to store the second character string in the first area by the basic input/output system in response to the owner of the first area being the basic input/output system.

In some embodiments of the present application, the basic input/output system includes a first pause module and a second read module, and the apparatus further includes:
a first pause module configured to pause storing the second character string in the first area by the basic input/output system in response to the owner of the first area being the baseboard management controller; and
a second read module configured to read the first owner field again by the basic input/output system to obtain the owner of the first area.

In some embodiments of the present application, the first data field further includes a first validity field; the first validity field is used for indicating whether the second character string in the first area is valid; the basic input/output system includes a first modification module, and the apparatus further includes:
a first modification module configured to indicate that the second character string of the first area is valid by modifying the first validity field by the basic input/output system.

In some embodiments of the present application, the baseboard management controller further includes a third read module, a fourth read module, a first extraction module and a first parsing module, and the apparatus further includes:
a third read module configured to read, by the baseboard management controller, the first validity field, and determine whether the second character string is valid;
a fourth read module configured to read the first owner field to obtain the owner of the first area by the baseboard management controller in response to the second character string being valid;
a first extraction module configured to extract the second character string by the baseboard management controller in response to the owner of the first area being the baseboard management controller; and
a first parsing module configured to parse the second character string by the baseboard management controller to obtain the first setup option.

In some embodiments of the present application, the first extraction module further includes:
a fifth read module configured to read the first data field by the baseboard management controller to obtain the length of the first character string and the information about whether the first character string is compressed;
a first determining module configured to determine whether the first character string exceeds the preset length range based on the length of the first character string by the baseboard management controller;
a second determining module configured to determine whether the first character string is compressed by the baseboard management controller based on the information about whether the first character string is compressed in response to the length of the first character string exceeding the preset length range;
a second ignoring module configured to ignore the second character string by the baseboard management controller in response to the first character string being not compressed; and
a second extraction module configured to extract the second character string by the baseboard management controller in response to the first character string being compressed.

In some embodiments of the present application, the first parsing module further includes:
a fifth read module configured to read the first data field by the baseboard management controller to obtain the first check value of the first character string;
a fourth calculation module configured to calculate a second check value of the first character string by the baseboard management controller based on the first character string;
a third determining module configured to compare, by the baseboard management controller, the first check value and the second check value, and determine whether the first check value and the second check value are the same;
a second ignoring module configured to ignore the second character string by the baseboard management controller in response to the first check value and the second check value being not the same; and
a second parsing module configured to parse the second character string by the baseboard management controller to obtain the first setup option in response to the first check value and the second check value being the same.

In some embodiments of the present application, the baseboard management controller further includes a second pause module and a sixth read module, and the apparatus further includes:
a second pause module configured to pause extracting the second character string by the baseboard management controller in response to the owner of the first area being the basic input/output system; and
a sixth read module configured to read the first owner field again by the baseboard management controller to obtain the owner of the first area.

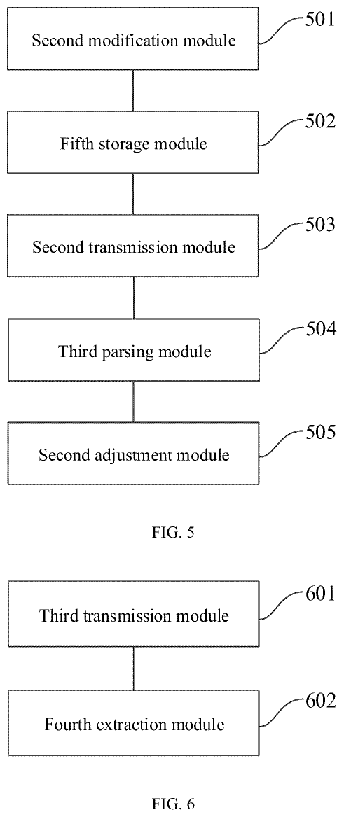

Referring to FIG. 5, FIG. 5 is a structural block diagram of an apparatus for processing a basic input/output system according to an embodiment of the present application, and the following modules may be included:
a second modification module 501 configured to modify a second character string to obtain a third character string corresponding to a second setup option by the baseboard management controller in response to the baseboard management controller transmitting the second setup option to the basic input/output system;
a fifth storage module 502 configured to store the third character string in the shared memory space by the baseboard management controller;
a second transmission module 503 configured to transmit the third character string to the basic input/output system via the PCIe path;
a third parsing module 504 configured to parse the third character string by the basic input/output system to obtain the second setup option; and
a second adjustment module 505 configured to adjust the basic input/output system by the basic input/output system based on the second setup option.

In some embodiments of the present application, the shared memory area further includes a second area used for storing the third character string; a second data field corresponding to the third character string is further stored in the second area; the second data field includes a second owner field and a second validity field; the second owner field is used for indicating an owner of the second area, and the second validity field is used for indicating whether the third character string in the second area is valid; the fifth storage module further includes:
a seventh read module configured to read the second owner field by the baseboard management controller to obtain the owner of the second area;
a sixth storage module configured to store the third character string in the second area by the baseboard management controller in response to the owner of the second area being the baseboard management controller; and
a third modification module configured to indicate that the third character string is valid by modifying the second validity field by the baseboard management controller.

In some embodiments of the present application, the basic input/output system further includes an eighth read module, a third extraction module and a fourth parsing module, and the apparatus further includes:
an eighth read module configured to read, by the basic input/output system, the second validity field and determine whether the third character string is valid; and
a third extraction module configured to extract the third character string by the basic input/output system in response to the third character string being valid.

In some embodiments of the present application, the shared memory area further includes a third area; and the second adjustment module further includes:
a fourth determining module configured to determine whether a second setup option satisfies a preset format requirement by the basic input/output system;
a third adjustment module configured to adjust the basic input/output system based on the second setup option by the basic input/output system in response to the second setup option satisfying the preset format requirement; and
a second conversion module configured to convert, by the basic input/output system, the second setup option into a fourth character string, and store the fourth character string in the third area in response to the second setup option not satisfying the preset format requirement; wherein the fourth character string is used for determining whether the second setup option satisfies the preset format requirement.

In some embodiments of the present application, the apparatus further includes:
a restart module configured to restart the server, such that the server is adapted to the second setup option, in response to the second setup option satisfying the preset format requirement.

Referring to FIG. 6, FIG. 6 is a structural block diagram of another apparatus for processing a baseboard management controller according to an embodiment of the present application, and the following modules may be included:
a third transmission module 601 configured to transmit the fourth character string to the baseboard management controller via the PCIe path in response to the basic input/output system transmitting the fourth character string to the baseboard management controller; and
a fourth extraction module 602 configured to extract, by the baseboard management controller, the fourth character string, and determine whether a second setup option corresponding to the fourth character string satisfies a preset format requirement based on the fourth character string.

The description is relatively simple with respect to the embodiment of the apparatus, since it is substantially similar to the embodiment of the method, to which reference is made for a partial explanation.

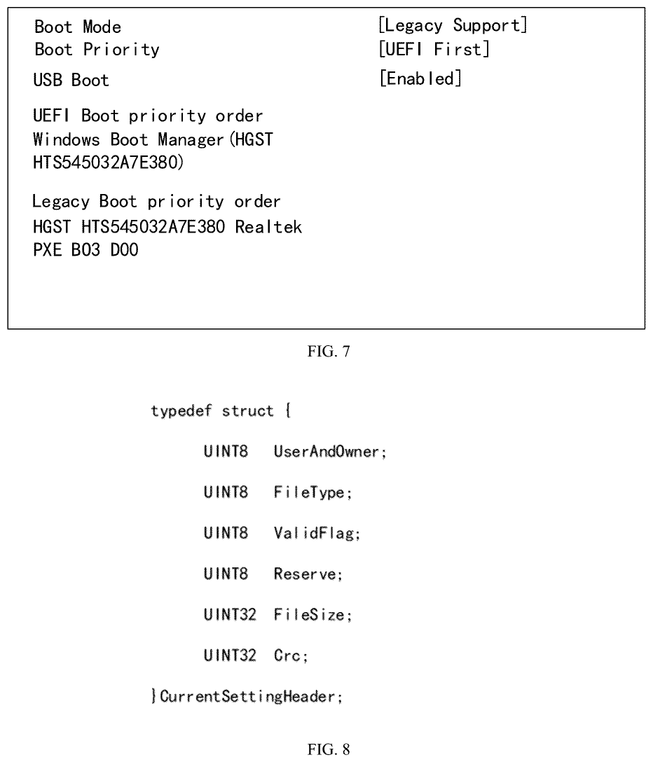

As an example provided herein, FIG. 7 is a schematic diagram showing a setup interface according to an embodiment of the present application; the setup interface is used to display the setup options which are used to save system parameters. The setup options include names of the setup options and values to which the setup options correspond. Different setup options have different format requirements, such as the names of the setup options and yes/no, the names of the setup options and any number from 1 to 10, etc. In FIG. 7, Boot Mode is a setup option, and Legacy Support is a value corresponding to the Boot Mode; Boot Priority is a setup option, and UEFI First is a value corresponding to the Boot Priority; USB Boot is a setup option, and Enabled is a value corresponding to the USB Boot; UEFI Boot priority order is a setup option, and Windows Boot Manager is a value corresponding to UEFI Boot priority order; Legacy Boot priority order is a setup option and HGST HTS545032A7E380 Realtek PXE BO3 D00 is a value corresponding to the UEFI Boot priority order.

As an example provided by the present application, FIG. 8 is a schematic diagram showing a first data field according to an embodiment of the present application. Typedef struct is an alias that defines an identifier and key, and has no specific meaning. The first data field, i.e., a data header of the first area, includes UserAndOwner, FileType, ValidFlag, Reserve, FileSize, and Crc. The UserAndOwner is an owner of a first area between the baseboard management controller and the basic input/output system. On the condition that the owner of the first area is the baseboard management controller, the basic input/output system cannot store the character string to the first area; on the condition that the owner of the first area is the basic input/output system, the baseboard management controller cannot store the character string in the first area, on the condition that the owner of the first area is not present, both the baseboard management controller and the basic input/output system may store the character string in the first area. The owner field needs to be modified to indicate the owner of the first area when the baseboard management controller or the basic input/output system stores the character string to the first area. The FileType may indicate whether the first character string is compressed or not, on the condition that the first character string is compressed, the FileType is 1, on the condition that the first character string is uncompressed, the FileType is 1. The ValidFlag may indicate whether the second character string is valid or not. When the basic input/output system ends transmitting the second character string to the baseboard management controller, the ValidFlag is modified to 1, it is indicated that the second character string is valid. When the baseboard management controller reads that ValidFlag becomes 1, it starts to parse the second character string. Reserve is a reserved field and has no meaning. The FileSize indicates the size of the second character string. The Cre is a first check value of the first character string.

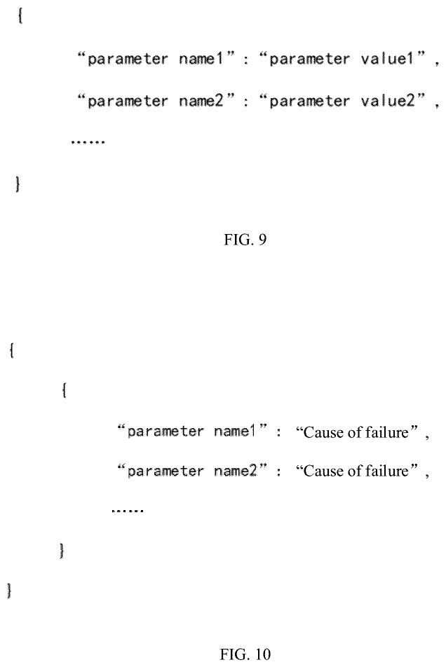

As an example provided by the present application, FIG. 9 is a schematic diagram showing a format of a second character string according to an embodiment of the present application. Parameter name1 is a setup option, and Parameter value1 is a value corresponding to Parameter name1; Parameter name2 is the setup option, and Parameter value2 is the value corresponding to Parameter name2.

As an example provided by the present application, FIG. 10 is a schematic diagram showing a format of a fourth character string according to an embodiment of the present application. The data format for correct setups is {“Result”: “EFI_SUCCESS”}; the data format for setup errors is as shown in FIG. 10: parameter name1 is a setup option, and the cause of failure is the value corresponding to Parameter name1; parameter name2 is a setup option, and the cause of failure is the value corresponding to Parameter name2.

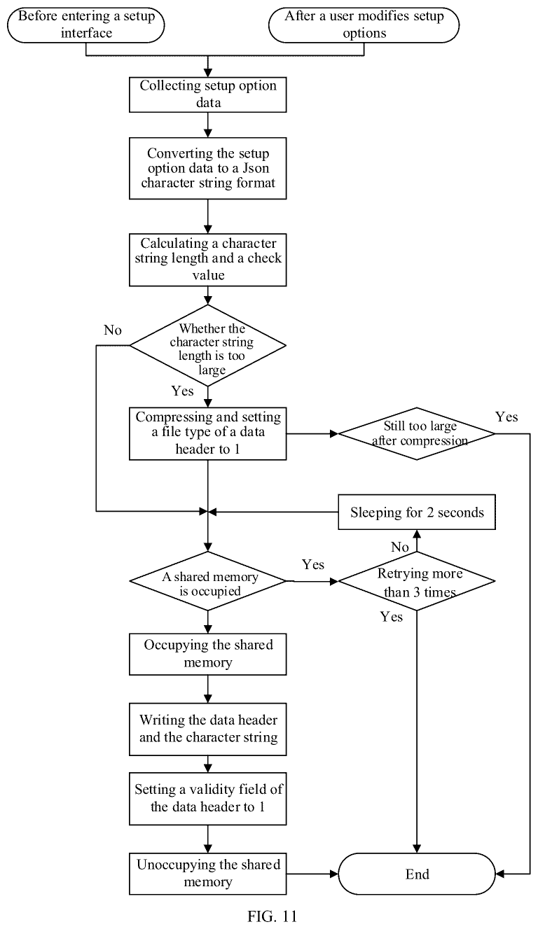

Referring to FIG. 11, FIG. 11 is a schematic flow diagram showing a basic input/output system transmitting a first setup option to a baseboard management controller according to an embodiment of the present application.
Step 1101, collecting setup option data by a basic input/output system before entering a setup interface or after a user modifies a setup option;
step 1102, converting the setup option data into a Json (JavaScript Object Notation) character string format by the basic input/output system;
step 1103, calculating the character string length and a check value by the basic input/output system; and
Step 1104, compressing and setting a file type of a data header as 1 by the basic input/output system in response to a length of the character string being too large; and proceeding to step 1109 in response to the character string being still too large after compression.
Step 1105, determining whether the shared memory is occupied by the basic input/output system, rejudging whether the shared memory is occupied is in response to the shared memory being occupied, and the number of retries being less than three times, and sleeping for two seconds; proceeding to step 1109 in response to the number of retries being greater than three; and occupying the shared memory in response to the shared memory being not occupied;
step 1106, writing the data header and the character string into the shared memory space by the basic input/output system;
step 1107, setting a validity field of the data header to 1 by the basic input/output system;
step 1108, unoccupying the shared memory by the basic input/output system; and
step 1109, end.

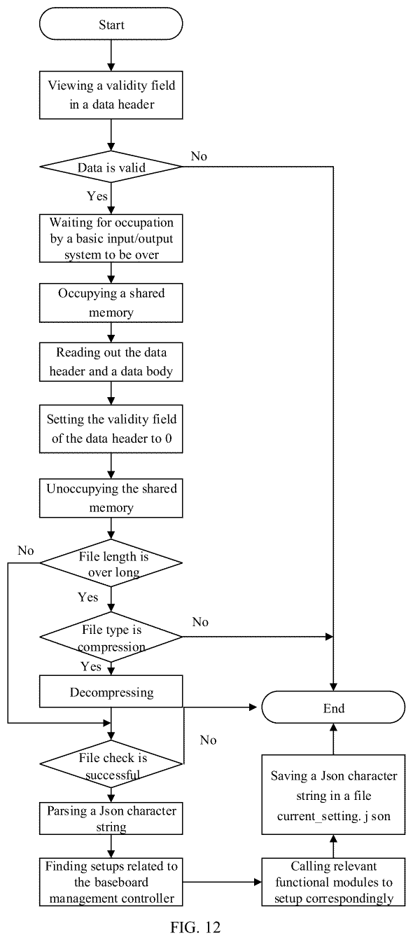

Referring to FIG. 12, FIG. 12 is a schematic flow diagram showing a baseboard management controller receiving a first setup option transmitted by a basic input/output system according to an embodiment of the present application.
Step 1201, start;
step 1202, checking the validity field in the data header by the baseboard management controller;
step 1203, determining whether the data is valid by the baseboard management controller; proceeding to step 1204 in response to the data being valid; proceeding to step 1216 in response to the data being invalid;
step 1204, waiting for occupation by a BIOS to be over by the baseboard management controller;
step 1205, occupying the shared memory by the baseboard management controller;
step 1206, reading out the data header and a data body by the baseboard management controller;
step 1207, setting the validity field of the data header to 0 by the baseboard management controller;
step 1208, unoccupying the shared memory by the baseboard management controller; and
step 1209 determining whether the file length is over-long by the baseboard management controller; proceeding to step 1211 in response to the file type being not too long; and determining whether the file type is compressed in response to the file length being too long; proceeding to step 1210 in response to the file type being compression; and proceeding to step 1216 in response to the file type being not compression;
step 1210, decompressing the data by the baseboard management controller;
step 1211, determining whether the file check is successful by the baseboard management controller; proceeding to step 1201 in response to the verification is successful; and proceeding to step 1216 in response to the verification fails;
step 1212, parsing a Json character string by the baseboard management controller;
step 1213, searching for a setup related to the BMC by the baseboard management controller;
step 1214, calling relevant functional modules to setup correspondingly by the baseboard management controller;
step 1215, saving the Json character string into a file cumrent_setting.jsom by the baseboard management controller; and
step 1216, end.

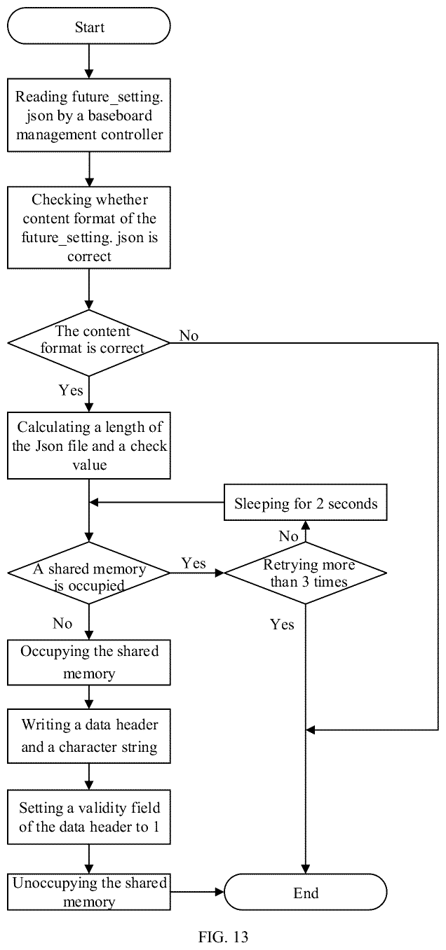

Referring to FIG. 13, FIG. 13 is a schematic flow diagram showing a baseboard management controller transmitting a second setup option to a basic input/output system according to an embodiment of the present application.
Step 1301, start;
step 1302, reading data by the BMC to determine whether a content format of future_setting.json is correct;
step 1303, checking whether the content format of the future_setting.jaon is correct by the baseboard management controller;
step 1304, calculating a length of the Json file and the check value by the baseboard management controller in response to the content format being correct; and proceeding to step 1309 in response to the content format being incorrect;
step 1305, determining whether the shared memory is occupied by the baseboard management controller; rejudging whether the shared memory is occupied in response to the shared memory being occupied, and the number of retries being less than three times, and sleeping for two seconds; in response to the number of retries being greater than three, proceeding to step 1309; occupying the shared memory in response to the shared memory being not occupied;
step 1306, writing the data header and the character string into the memory space by the baseboard management controller;
step 1307, setting the validity field of the data header to 1 by the baseboard management controller;
step 1308, unoccupying the shared memory by the baseboard management controller; and
step 1309, end.

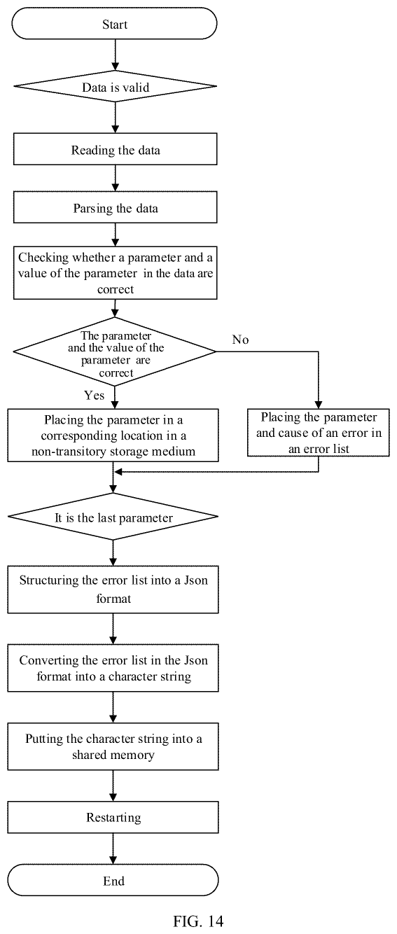

Referring to FIG. 14, FIG. 14 is a schematic flow diagram showing a basic input/output system processing a second setup option according to an embodiment of the present application.
Step 1401, start;
step 1402, determining whether the data is valid by the basic input/output system;
step 1403, reading data by the basic input/output system;
step 1404, parsing data by the basic input/output system;
step 1405, checking whether a parameter and a value of the parameter in data are correct by the basic input/output system;
step 1406, putting the parameter into a corresponding position in the non-transitory storage medium by the basic input/output system in response to the parameter in the checked data and the value of the parameter being correct; putting the parameter and cause of an error into an error list in response to the parameter in the check data and the value of the parameter being incorrect;
step 1407, determining whether the parameter in the checked data is the last parameter by the basic input/output system;
step 1408, structuring the error list into a Json format by the basic input/output system;
step 1409, converting the error list in the Json format into the character string by the basic input/output system;
step 1410, putting the character string into the shared memory by the basic input/output system;
step 1411, restarting the server; and
step 1412, end.

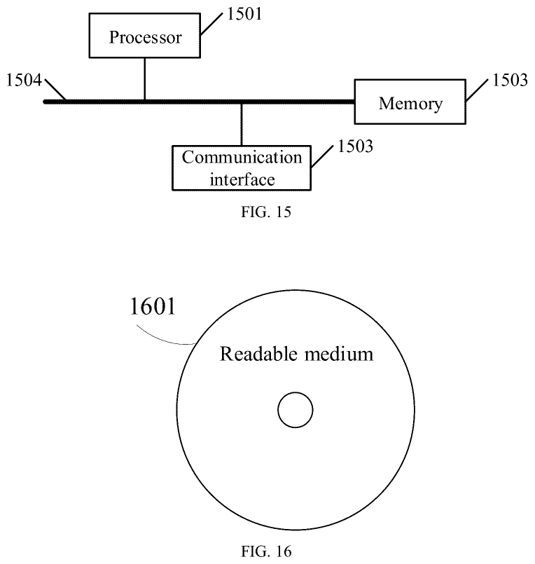

In addition, an electronic device is further provided by the embodiment of the present application, as shown in FIG. 15, the electronic device includes a processor 1501, a communication interface 1502, a memory 1503 and a communication bus 1504, wherein the processor 1501, the communication interface 1502 and the memory 1503 complete communication with each other via the communication bus 1504;
the memory 1503 is configured to store a computer program; and
the processor 1501 is configured to implement the method of the embodiment of the present application when executing the programs stored on the memory 1503.

The communication bus mentioned in the above-mentioned terminal may be a peripheral component interconnect (PCI) bus or an extended industry standard architecture (EISA) bus, etc. The communication bus may be divided into an address bus, a data bus, a control bus, etc. For case of illustration, only one bold line is shown in the figure, but does not indicate that there is only one bus or type of bus.

The communication interface is used for communication between the terminal and other devices described above.

The memory may include random access memory (RAM) or may also include non-transitory memory, e.g., at least one disk memory. The memory may also be at least one memory apparatus located remotely from the aforementioned processor.

The above-mentioned processor may be a general-purpose processor, including a central processing unit (CPU), a network processor (NP), etc.; it may also be a digital signal processing (DSP), an application specific integrated circuit (ASIC), a field-programmable gate array (FPGA) or other programmable logic devices, discrete gate or transistor logic devices, and discrete hardware components.

As shown in FIG. 16, in yet another embodiment provided by the present application, a non-transitory readable storage medium 1601 is further provided, which has stored therein instructions which, when executed on a computer, cause the computer to perform a method of the embodiment of the present application.

In yet another embodiment provided by the present application, a computer program product is further provided, which includes instructions which, when executed on a computer, cause the computer to perform the method of the embodiment of the present application.

In the embodiments described above, they may be implemented in whole or in part by software, hardware, firmware, or any combination thereof. When implemented in software, it may be implemented in whole or in part as a computer program product. The computer program product includes one or more computer instructions. The computer program instructions, when loaded and executed on a computer, result in whole or in part in the processes or functions described according to embodiments of the present application. The computer may be a general-purpose computer, a special-purpose computer, a computer network, or other programmable apparatuses. The computer instructions may be stored in a non-transitory readable storage medium or transmitted from one non-transitory readable storage medium to another non-transitory readable storage medium. For example, the computer instructions may be transmitted from one website, computer, server, or data center to another website, computer, server, or data center by wire (e.g., coaxial cable, fiber optic, digital subscriber line (DSL)) or wirelessly (e.g., infrared, wireless, microwave, etc.). The non-transitory readable storage medium may be any available medium that may be accessed by a computer or a data storage device including one or more available media integrated into a server, a data center, or the like. Usable media may be magnetic media, (e.g., floppy disk, hard disk, magnetic tape), optical media (e.g., digital versatile disc (DVD) or digital video disc, optical disk storage media), or semiconductor media (e.g., solid state disk (SSD)), etc.

It is noted that relational terms such as first and second, and the like, may be used herein to distinguish one entity or action from another entity or action without necessarily requiring or implying any actual such relationship or order between such entities or actions. Further, the terms “include”, “including”, or any other variation thereof, are intended to cover a non-exclusive inclusion, such that a process, method, article, or device that includes a list of elements does not include only those elements but may include other elements not expressly listed or inherent to such process, method, article, or device. An element proceeded by the phrase “includes a . . . ” does not, without more constraints, preclude the existence of additional identical elements in the process, method, article, or device that includes the element.

The various embodiments of the description are described in a related manner, reference being made to the same and similar parts of the various embodiments, and each of the embodiments focuses on the differences from the other embodiments. Especially for the system embodiment, since it is substantially similar to the method embodiment, the description is relatively simple, and reference may be made to the partial description of the method embodiment for relevant points.

The foregoing is merely illustrative of the preferred embodiments of the present application and is not intended to limit the scope of the present application. Any modifications, equivalent replacements, improvements, etc., made within the spirit and principles of the present application shall be included within the scope of protection of the present application.

1. A method for processing a baseboard management controller, applied to a server, wherein the server comprises the baseboard management controller, a basic input/output system and a shared memory space between the baseboard management controller and the basic input/output system; the basic input/output system further provides a setup interface; the basic input/output system is connected to the baseboard management controller via a peripheral component interconnect express (PCIe) path, and the setup interface is used for displaying setup options; and the method comprises:
collecting, by the basic input/output system, a first setup option and storing the first setup option in the shared memory space in response to the basic input/output system transmitting the first setup option to the baseboard management controller, before the setup interface is displayed and/or after the setup option is modified via the setup interface;
transmitting the first setup option to the baseboard management controller via the PCIe path; and
adjusting the baseboard management controller based on the first setup option by the baseboard management controller.

2. The method according to claim 1, wherein the shared memory space comprises a first area; and the step of collecting the first setup option and storing the first setup option in the shared memory space further comprises:
converting the collected first setup option into a first character string by the basic input/output system;
calculating, by the basic input/output system, a length of the first character string based on the first character string, and determining whether the length of the first character string exceeds a preset length range;
taking the first character string as a second character string by the basic input/output system in response to the length of the first character string not exceeding the preset length range; and
storing the second character string in the first area by the basic input/output system.

3. The method according to claim 2, wherein the first area further stores a first data field corresponding to the first character string; and the method further comprises:
calculating a first check value of the first character string based on the first character string by the basic input/output system; and
storing the length of the first character string and the first check value in the first data field by the basic input/output system.

4. The method according to claim 3, wherein the method further comprises:
compressing the first character string by the basic input/output system to obtain a compressed character string in response to the length of the first character string exceeding the preset length range;
storing information about whether the first character string is compressed in the first data field by the basic input/output system;
calculating, by the basic input/output system, a length of the compressed character string, and determining whether the length of the compressed character string exceeds the preset length range; and
taking the compressed character string as the second character string by the basic input/output system in response to the length of the compressed character string being within the preset length range.

5. The method according to claim 3, wherein the first data field further comprises a first owner field; the first owner field is used for indicating an owner of the first area; and the step of storing the second character string in the first area further comprises:
reading the first owner field by the basic input/output system to obtain the owner of the first area; and
modifying the first owner field to indicate that the owner of the first area is the basic input/output system and storing the second character string in the first area by the basic input/output system in response to the owner of the first area being the basic input/output system or the first area being not used.

6. The method according to claim 5, wherein the method further comprises:
pausing storing the second character string in the first area by the basic input/output system in response to the owner of the first area being the baseboard management controller; and
reading the first owner field again by the basic input/output system to obtain the owner of the first area.

7. The method according to claim 5, wherein the first data field further comprises a first validity field; the first validity field is used for indicating whether the second character string in the first area is valid; and after the step of storing the second character string in the first area, the method further comprises:
indicating that the second character string of the first area is valid by modifying the first validity field by the basic input/output system.

8. The method according to claim 7, wherein before the baseboard management controller adjusts the baseboard management controller based on the first setup option, the method further comprises:
reading, by the baseboard management controller, the first validity field, and determining whether the second character string is valid;
reading the first owner field by the baseboard management controller to obtain the owner of the first area in response to the second character string being valid;
modifying the first owner field to indicate that the owner of the first area is the baseboard management controller and extracting the second character string by the baseboard management controller in response to the owner of the first area being the baseboard management controller or the first area being not used; and
parsing the second character string by the baseboard management controller to obtain the first setup option.

9. The method according to claim 8, wherein the step of extracting the second character string further comprises:
reading the first data field by the baseboard management controller to obtain the length of the first character string and information about whether the first character string is compressed;
determining whether the first character string exceeds the preset length range based on the length of the first character string by the baseboard management controller;
determining whether the first character string is compressed by the baseboard management controller based on the information about whether the first character string is compressed in response to the length of the first character string exceeding the preset length range;
ignoring the second character string by the baseboard management controller in response to the first character string being not compressed; and
extracting the second character string by the baseboard management controller in response to the first character string being compressed.

10. The method according to claim 8, wherein the step of parsing the second character string to obtain the first setup option further comprises:
reading the first data field by the baseboard management controller to obtain the first check value of the first character string;
calculating a second check value of the first character string by the baseboard management controller based on the first character string;
comparing, by the baseboard management controller, the first check value and the second check value, and determining whether the first check value and the second check value are the same;
ignoring the second character string by the baseboard management controller in response to the first check value and the second check value being not the same; and
parsing the second character string by the baseboard management controller to obtain the first setup option in response to the first check value and the second check value being the same.

11. The method according to claim 8, wherein the method further comprises:
pausing extracting the second character string by the baseboard management controller in response to the owner of the first area being the basic input/output system; and
reading the first owner field again by the baseboard management controller to obtain the owner of the first area.

12. A method for processing a basic input/output system, applied to a server, wherein the server comprises a baseboard management controller, the basic input/output system and a shared memory space between the baseboard management controller and the basic input/output system; the basic input/output system is connected to the baseboard management controller via a peripheral component interconnect express (PCIe) path; the baseboard management controller stores a second character string that is preset; and the method comprises:
modifying the second character string to obtain a third character string corresponding to a second setup option by the baseboard management controller in response to the baseboard management controller transmitting the second setup option to the basic input/output system;
storing the third character string in the shared memory space by the baseboard management controller;
transmitting the third character string to the basic input/output system via the PCIe path;
parsing the third character string by the basic input/output system to obtain the second setup option; and
adjusting the basic input/output system by the basic input/output system based on the second setup option.

13. The method according to claim 12, wherein the shared memory area further comprises a second area, the second area is used for storing the third character string; a second data field corresponding to the third character string is further stored in the second area; the second data field comprises a second owner field and a second validity field; the second owner field is used for indicating an owner of the second area, and the second validity field is used for indicating whether the third character string in the second area is valid; and the step of storing the third character string in the shared memory space further comprises:
reading the second owner field by the baseboard management controller to obtain the owner of the second area;
modifying the second owner field to indicate that the owner of the second area is the baseboard management controller and storing the third character string in the second area by the baseboard management controller in response to the owner of the second area being the baseboard management controller or the second area being not used; and
indicating that the third character string is valid by modifying the second validity field by the baseboard management controller.

14. The method according to claim 13, wherein before the step of parsing the third character string to obtain the second setup option, the method further comprises:
reading, by the basic input/output system, the second validity field and determining whether the third character string is valid; and
extracting the third character string by the basic input/output system in response to the third character string being valid.

15. The method according to claim 14, wherein the shared memory area further comprises a third area; and the step of adjusting the basic input/output system based on the second setup option further comprises:
determining whether the second setup option satisfies a preset format requirement by the basic input/output system;
adjusting the basic input/output system based on the second setup option by the basic input/output system in response to the second setup option satisfies the preset format requirement; and
converting, by the basic input/output system, the second setup option into a fourth character string, and storing the fourth character string in the third area in response to the second setup option not satisfying the preset format requirement; wherein the fourth character string is used for determining whether the second setup option satisfying the preset format requirement.

16. The method according to claim 15, wherein the method further comprises:
restarting the server, such that the server is adapted to the second setup option, in response to the second setup option satisfying the preset format requirement.

17. A method for processing a baseboard management controller, applied to a server, wherein the server comprises the baseboard management controller, a basic input/output system and a shared memory space between the baseboard management controller and the basic input/output system; the basic input/output system is connected to the baseboard management controller via a peripheral component interconnect express (PCIe) path; the shared memory space stores a fourth character string that is preset; and the method comprises:
transmitting the fourth character string to the baseboard management controller via the PCIe path in response to the basic input/output system transmitting the fourth character string to the baseboard management controller; and
extracting, by the baseboard management controller, the fourth character string, and determining whether a second setup option corresponding to the fourth character string satisfies a preset format requirement based on the fourth character string.

18. An apparatus for processing a baseboard management controller, disposed in a server, wherein the server comprises the baseboard management controller, a basic input/output system and a shared memory space between the baseboard management controller and the basic input/output system; the basic input/output system further provides a setup interface; the basic input/output system is connected to the baseboard management controller via a peripheral component interconnect express (PCIe) path, and the setup interface is used for displaying setup options; and the apparatus comprises a processor, a communication interface, a memory, and a communication bus, wherein the processor, the communication interface and the memory communicate with each other via the communication bus;
the memory is configured to store a server program; and
the processor, in response to executing the program stored on the memory, implements steps of the method according to claim 1.

19. An apparatus for processing a basic input/output system, applied to a server, wherein the server comprises a baseboard management controller, the basic input/output system and a shared memory space between the baseboard management controller and the basic input/output system; the basic input/output system is connected to the baseboard management controller via a peripheral component interconnect express (PCIe) path; the baseboard management controller stores a second character string that is preset; and the apparatus comprises a processor, a communication interface, a memory, and a communication bus, wherein the processor, the communication interface and the memory communicate with each other via the communication bus;
the memory is configured to store a server program; and
the processor, in response to executing the program stored on the memory, implements steps of the method according to claim 12.

20. An apparatus for processing a baseboard management controller, applied to a server, wherein the server comprises the baseboard management controller, a basic input/output system and a shared memory space between the baseboard management controller and the basic input/output system; the basic input/output system is connected to the baseboard management controller via a peripheral component interconnect express (PCIe) path; the shared memory space stores a fourth character string that is preset; and the apparatus comprises a processor, a communication interface, a memory, and a communication bus, wherein the processor, the communication interface and the memory communicate with each other via the communication bus;
the memory is configured to store a server program; and
the processor, in response to executing the program stored on the memory, implements steps of the method according to claim 17.
